(19) United States
(12) Patent Application Publication
(10) Pub. No.: US 2025/0139500 A1
(43) Pub. Date: May 1, 2025

(54) SYNTHETIC DATA TESTING IN MACHINE LEARNING APPLICATIONS

(71) Applicant: INTERNATIONAL BUSINESS MACHINES CORPORATION, ARMONK, NY (US)

(72) Inventors: Xiao Ming Ma, Xi'an (CN); Si Er Han, Xi'an (CN); Xue Ying Zhang, Xi'an (CN); Jing James Xu, Xi'an (CN); Jing Xu, Xi'an (CN); Ji Hui Yang, Beijing (CN); Rui Wang, XIAN (CN)

(21) Appl. No.: 18/496,983

(22) Filed: Oct. 30, 2023

(51) Int. Cl. G06N 20/00; G06N 5/04

(52) U.S. Cl. CPC G06N 20/00; G06N 5/04

(57) ABSTRACT

Determining whether synthetic data is sufficient for utilization in connection with one or more machine learning models. The computing device accesses a protected batch of data associated with a machine learning model. The computing device accesses a simulated batch of data, the simulated batch of data based upon but anonymizing the protected batch of data. The computing device accesses one or more comparisons of one or more variables in the protected batch of data and the simulated batch of data to obtain a similarity value. The computing device performs a machine learning function utilizing at least in-part the simulated batch of data if the similarity value exceeds a similarity threshold.

### FIELD OF THE INVENTION

The present invention relates generally to machine learning and more particularly to anonymization of data for utilization with machine learning applications.

### BACKGROUND

As the amount of data collected by various computer devices regarding every individual increases every day, a corresponding increasing number of foreign and domestic jurisdictions are enacting laws, regulations, rules, etc. which provide various requirements for data protection of personal data. These laws, regulations, etc. may provide differing provisions for protection of personal data based on, for example, the specific type of data, where the data is physically stored, personal choices regarding the data, as well as other considerations. The trouble with these, however, is that the requirements are not only stringent, but also may differ across different jurisdictions, making compliance very difficult (if not impossible). The value of data, however, is unquestionable in the twenty-first century. Data is widely used in a variety of fields at present, but particularly in machine learning where large amounts of high-quality data are necessary to not only train machine learning models, but also make inferences by trained machine learning models, as well as a multitude of other applications.

One approach increasingly utilized to allow large amounts of data to be used in various ways is generation of synthetic data based upon real data. The synthetic data is generated to contain many of the same attributes as the original, protected data for usage by various applications. This provides, for example, for data scientists to utilize the data to confirm accuracy of models, train machine learning models, make predictions by trained machine learning models, etc. while still maintaining compliance with data protection requirements for use of the data.

In order to make sure that the synthetic data is sufficiently close to the original data that the results are still correct, a need presents itself for methodology to determine whether synthetic data is sufficiently close in attributes to original, protected data to provide for utilization of the synthetic data in with machine learning or for utilization in other ways.

### SUMMARY

Embodiments of the present invention disclose a method, system, and computer program product for determining whether synthetic data is sufficient for utilization in connection with one or more machine learning models. The computing device accesses a protected batch of data associated with a machine learning model. The computing device accesses a simulated batch of data, the simulated batch of data based upon but anonymizing the protected batch of data. The computing device accesses results of one or more comparisons of one or more variables in the protected batch of data and the simulated batch of data to obtain a similarity value. The computing device performs a machine learning function utilizing at least in-part the simulated batch of data if the similarity value exceeds a similarity threshold.

Embodiments of the present invention also disclose an alternative method, system, and computer program product for determining whether synthetic data is sufficient for utilization in connection with one or more machine learning models. The computing device accesses a protected batch of data associated with a machine learning model. The computing device accesses a simulated batch of data, the simulated batch of data based upon but anonymizing the protected batch of data. Results of comparison of one or more variables in the protected batch of data and the simulated batch of data are accessed to obtain a similarity value. The computing device performs a machine learning function utilizing at least in-part the simulated batch of data if the similarity value exceeds a similarity threshold, the machine learning function performing by one or more machine learning models an inference utilizing at least in part the simulated batch of data.

Embodiments of the present invention also another alternative method, system, and computer program product for determining whether synthetic data is sufficient for utilization in connection with one or more machine learning models. The computing device accesses a protected batch of data associated with a machine learning model. The computing device accesses a simulated batch of data, the simulated batch of data based upon but anonymizing the protected batch of data. Results of comparison of one or more variables in the protected batch of data and the simulated batch of data are accessed to obtain a similarity value. The computing device performs a machine learning function utilizing at least in part the simulated batch of data, the machine learning function training a machine learning model with the simulated batch of data.

### BRIEF DESCRIPTION OF THE DRAWINGS

FIG. 1 represents a networked computer environment 100, in accordance with an embodiment of the present invention.

FIG. 2 is a functional block diagram illustrating synthetic data test modules 200, in accordance with an embodiment of the present invention.

FIG. 3 is a flowchart 300 depicting operational steps that a hardware component of a hardware appliance may execute, in accordance with an embodiment of the invention.

FIG. 4 is a flowchart 400 depicting operational steps that a hardware component of a hardware appliance may execute, in accordance with an embodiment of the invention.

FIG. 5 is a flowchart 500 depicting operational steps that a hardware component of a hardware appliance may execute, in accordance with an embodiment of the invention.

### DETAILED DESCRIPTION

The presently disclosed embodiments relate one or more methods, systems, and computer program products to determine whether synthetic data is sufficient for utilization in connection with one or more machine learning models. By utilizing synthetic data, various requirements regarding personal data are complied with, while high quality results are still obtained. Synthetic data, in various embodiments of the invention, has similar “attributes” as real personal data, and thereby provide similar patterns, statistics, distributions, features, correlations, etc. but not actually contain any personal data regarding any real-world individual. Synthetic data, as used herein, may also be referred to as simulated data. Synthetic data provides all, or nearly all, of the benefits of real data. Thus, a machine learning model which is trained upon the synthetic data, or uses the synthetic data to make an inference is guaranteed to provide high quality results relying merely upon the synthetic data. Presently disclosed embodiments may be implemented as part of an automated machine learning environment, as part of a data science related application, as a plug-in to a web browser, as a stand-alone application, or in any other way while being contemplated by embodiments of the invention disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with synthetic data test modules 200. In addition to modules 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112. persistent storage 113 (including operating system 122 and modules 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

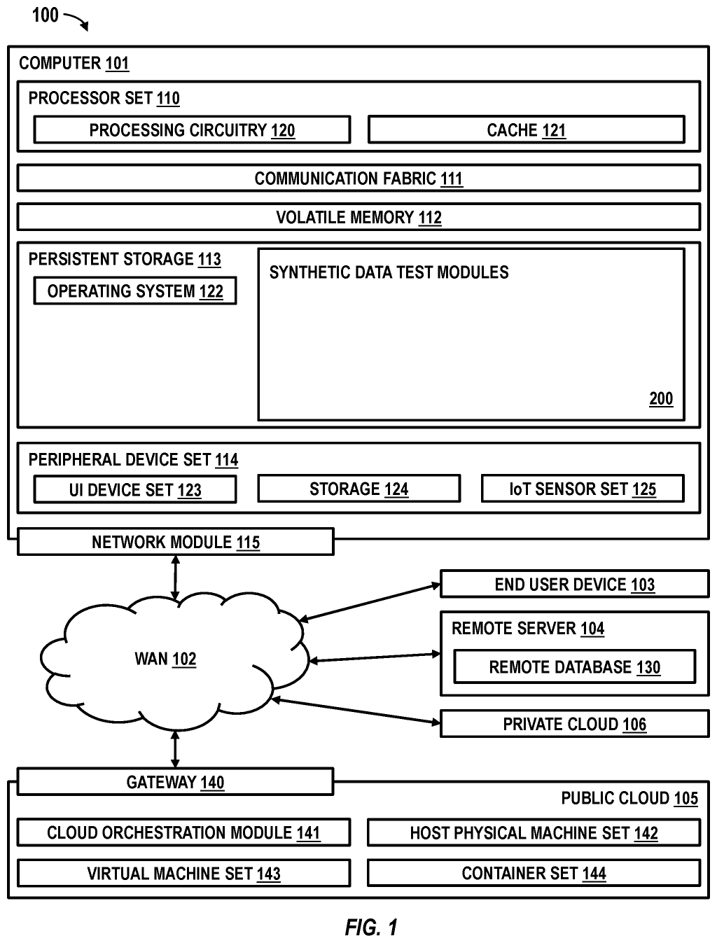

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processor set 110 may be alternatively be referred to herein as one or more “computing device(s),” but computing devices may also refer to one or more CPUs, microchips, integrated circuits, embedded systems, or the equivalent, presently existing or after-arising. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in modules 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in modules 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

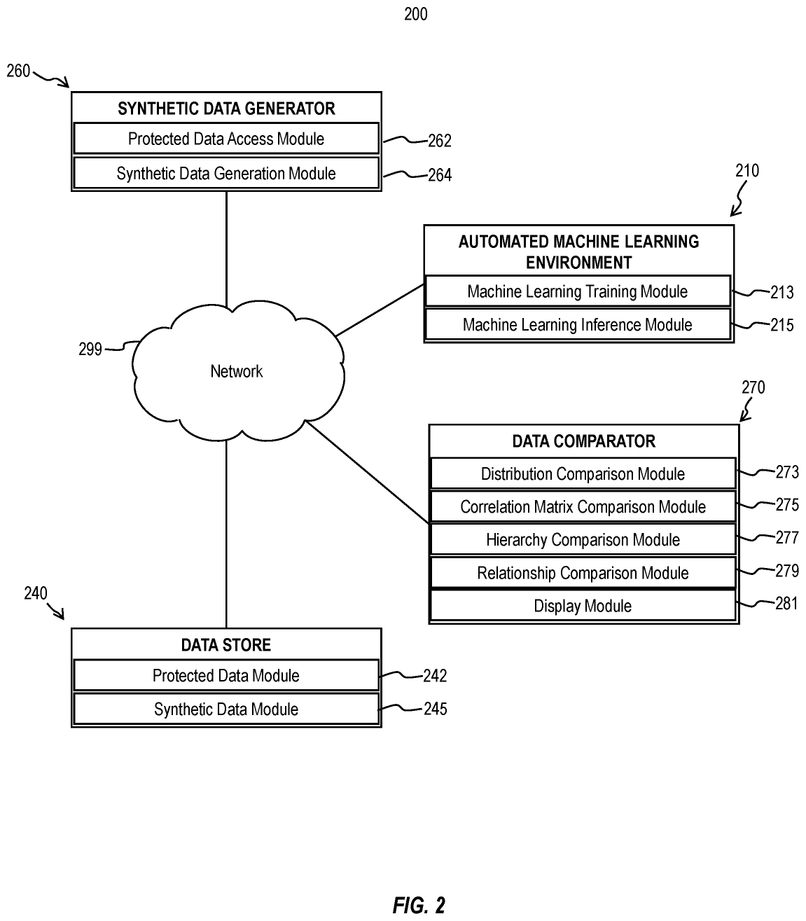

FIG. 2 is a functional block diagram illustrating synthetic data test modules 200, in accordance with an embodiment of the present invention. In an embodiment of the invention, such as displayed in FIG. 2, automated machine learning environment 210 is operatively connected to data store 240, synthetic data generator 260, and data comparator 270. Automated machine learning environment 210 may be any sort of computer software (and, in various embodiments, associated computer hardware) for providing various functionality in connection with machine learning models, including training, modifying, selecting, parameterization, and/or making inferences utilizing trained machine learning models. Automated machine learning environment 210 may also provide other functionality (not discussed herein). In various embodiments, automated machine learning environment 210 may rely upon real or simulated batches of data (available from data store 240) in training machine learning models and/or making inferences based upon machine learning models. In embodiments of the invention relying upon synthetic data, synthetic data is generated from protected batches of data (as further discussed herein). Synthetic data is “tested” by confirming its validity with data comparator 270.

As further displayed in FIG. 2, in various embodiments of the invention, automated machine learning environment 210, data store 240, synthetic data generator 260, and data comparator 270 are connected to and via network 299. In various embodiments of the invention, network 299 represents, for example, any sort of computer network such as a local area network (LAN), a wide area network (WAN) such as the Internet, and includes wired, wireless, or fiber optic connections. In various embodiments, network 299 is substantially the same as WAN 102, discussed in connection with FIG. 1 herein. In general, network 299 may be any combination of connections and protocols that will support communications between self-supervised learning module 210 and image repository 280, in accordance with embodiments of the invention. In further embodiments of the invention, network 299 may represent an internal bus associated with a single or multicore processor executing one or more of automated machine learning environment 210, data store 240, synthetic data generator 260, and data comparator 270.

Discussing elements displayed in FIG. 2 in further detail, automated machine learning environment 210 represents software (and, in various embodiments, associated computer hardware), for providing various functionality in connection with machine learning models, including training, modifying, selecting, parameterization, and/or making inferences utilizing trained machine learning models. Automated machine learning environment 210 may be implemented as a stand-alone application. as a plug-in to a web browser, as a portion of a distributed or cloud application, or in any other way while being contemplated as within the scope of the invention. In various embodiments of the invention, automated machine learning environment 210 includes one or more of machine learning training module 213 and machine learning inference module 215.

Machine learning training module 213 represents software and/or hardware for performing one or more functions in connection with training, re-training, or otherwise modifying one or more machine learning models. Machine learning model(s) associated with machine learning training module 213, in various embodiments of the invention, are trained using one or more of protected batch of data and/or simulated batch of data stored by data store 240. Machine learning models trained and/or re-trained by machine learning module 213 may be implemented as any form of neural network, random forest, support vector machines, symbolic regression, etc. (or the presently existing or after-arising equivalent) and may utilize supervised, unsupervised, semi-supervised, or reinforcement learning. Machine learning model(s) trained by machine learning training module 213 may be utilized in various ways, in connection with embodiments of the invention. In further embodiments of the invention, machine learning models may be pre-trained externally and stored within automated machine learning environment 210. As one of skill in the art understands, machine learning models must be “trained,” or “re-trained” using large amounts of data (or may use data in modifying machine learning models in other ways). As discussed elsewhere herein, protected data which may be used in training/re-training/otherwise modifying machine learning model(s). In embodiments of the invention, data comparator 270 generates a similarity value indicating a similarity value between a protected batch of data and a simulated batch of data, and if the similarity value exceeds a similarity threshold, machine learning training module 213 performs a function based upon the simulated batch of data.

Machine learning inference module 215 represents software and/or hardware for performance of various functions by previously trained or re-trained machine learning models (such as generation of inferences or other machine learning model outputs based upon real data and/or simulated data). As discussed previously herein, machine learning models are trained/re-trained/modified by machine learning training module 213, or, in alternative embodiments, are pre-trained externally. The inferences or other functions performed by machine learning models may be based in whole or in part on real data. synthetic data, or some combination of these. As one of skill in the art understands, machine learning models can create many different results at present, and more applications continue to be discovered. By non-limiting example, inferences may include in fraud prevention, computer vision, self-driving cars, data security, computer assistants, spam filters, healthcare, etc. Other applications include computer-generated output from large language models, chat bots, creative outputs (such as music or computer-generated art), marketing, and others. Machine learning models, however, in order to perform their functions rely upon utilization of data, which may be of a personal nature. In order to comply with various requirements, laws, etc. regarding protection of personal data, it is beneficial or necessary to rely in certain applications upon simulated batches of data, which may or may not correctly reflect protected, real data, as further discussed herein. In embodiments of the invention, data comparator 270 generates a similarity value indicating a similarity value between a protected batch of data and a simulated batch of data, and if the similarity value exceeds a similarity threshold, machine learning inference module 215 performs a function based upon the simulated batch of data.

Continuing with regard to FIG. 2, data store 240 represents software (and, in various embodiments, associated computer hardware), for storage/providing access to various types of data for utilization in connection with automated machine learning environment 210. Data store 240 may be implemented as any sort of database, datastore, etc. which is capable of storage and/or access to various types of data. In various embodiments of the invention, data store 240 includes one or more of protected data module 242 and synthetic data module 245.

Protected data module 242 represents software (and, in various embodiments, associated computer hardware) for storage/providing access specifically to protected batch(es) of data to be utilized, in various embodiments, in connection with automated machine learning environment 210, synthetic data generator 260, or otherwise. The “protected batch(es) of data” or “protected data” is stored by protected data module 242 may be collected in various ways (as understood by one of skill in the art), such as by monitoring of internet search results, interactions with advertisements, news articles read, purchases made, etc., and may reflect information directly correlated to real-world people such as names, ages, gender, home addresses, location identifiers, IP addresses, medical data, etc., which may be subject to various legal, ethical, and regulatory considerations that prevent widespread dissemination. Despite these considerations, data is a necessary part of performing various functions in connection with machine learning models training/re-training/modifying/making inferences/performing other functions. High quality data is necessary for corresponding high quality functionality. In embodiments of the invention, protected batches of data are accessed by synthetic data generator 260 to generated simulated batches of data for storage and access provision by synthetic data module 245.

Synthetic data module 245 represents software (and, in various embodiments, associated computer hardware) for storage/providing access specifically to “synthetic batch(es) of data” to be utilized in connection with automated machine learning environment 210 or otherwise. As discussed herein, “synthetic data,” “synthetic batches of data,” “simulated data,” and/or “simulated batches of data” are used synonymously and interchangeably. Synthetic data stored by synthetic data module 245 is generated by synthetic data generator 260 from protected batch(es) of data stored by protected data module 242 (as discussed further in connection with synthetic data generator 260). In embodiments of the invention, synthetic data is utilized by automated machine learning environment 210 to train/re-train/modify/make inferences/perform other functions in connection with machine learning models, as discussed further herein (especially in connection with machine learning training module 213 and machine learning inference module 215).

Still continuing with regard to FIG. 2, synthetic data generator 260 represents software (and, in various embodiments, associated computer hardware) for generation of synthetic data (a.k.a. simulated data) from protected batches of data stored by protected data module 242. In various embodiments of the invention, synthetic data generator 260 includes protected data access module 262 and synthetic data generation module 264.

Protected data access module 262 represents software and/or hardware for access of protected data from data store 240 (including necessary secure connections in order to transmit this data securely). Protected data stored by data store 240 includes various personal data and otherwise which may be collected, in various embodiments of the invention, by monitoring of internet search results, interactions with advertisements, news articles read, purchases made, etc., and may reflect information directly correlated to real-world people such as names, ages, gender, home addresses, location identifiers, IP addresses, medical data, etc., which may be subject to various legal, ethical, and regulatory considerations that prevent widespread dissemination. Generally, in embodiments of the invention, protected data access module 262 makes protected data available from data store 240 to synthetic data generator 262 to generate synthetic data for further utilization in connections with embodiments disclosed herein.

Synthetic data generation module 264 represents software and/or hardware for generation of synthetic data from protected data (accessed and provided by protected data access module 262). Synthetic data closely mimics the properties and characteristics of real, protected data and possesses, for example, the same or similar variables, distributions of these variables, similar covariates, etc., but since the data does reflect any real-world individuals, synthetic data may be used in situations where state, federal, international, etc. data protection laws and regulations may apply. Synthetic data, in various embodiments of the invention, may be utilized to train AI models, generate inferences with the help of AI models, validate simulations, validation test results, etc. (as discussed further herein). In various embodiments of the invention, synthetic data may be generated in various ways, and all are contemplated as within the scope of synthetic data generation module 264. Synthetic data, for example, may be produced by synthetic data generation module 264 using various computer-implemented algorithms designed for the purpose (such as by drawing random numbers within a distribution displayed by protected data). Synthetic data may be created synthetic data generation module 264 executing computer simulations (such as by agent-based modeling). Synthetic data generation module 264 may utilize an artificial intelligence/machine learning model (such as a generative model or other transformer-based foundation model/variational autoencoder/etc.) to generate synthetic data from protected data. New methodology to generate high-quality synthetic data are continuously being discovered, and all are contemplated as within the scope of the invention. In various embodiments of the invention, synthetic data is generated pre-labeled, avoiding the need for labeling of the data after collection, presenting immense time savings in connection with machine learning activities.

FIG. 2 also displays data comparator 270 representing software and/or hardware for comparing one or more variables in the protected batch of data (stored by protected data module 242) versus synthetic data stored by synthetic data module 245. In various embodiments of the invention, data comparator 270 includes one or more of distribution comparison module 273, correlation matrix comparison module 275, hierarchy comparison module 277, relationship comparison module 279, and display module 281. In various embodiments of the invention, one or more of distribution comparison module 273, correlation matrix comparison module 275, hierarchy comparison module 277, and relationship comparison module 279 are combined or absent.

Distribution comparison module 273 represents software and/or hardware for identification and/or comparison of distributions of one or more variables associated with the protected batch of data and the simulated batch of data. In embodiments of the invention, a larger number of variables associated with the protected batch of data and the simulated batch of data are analyzed for similarity. As one of skill in the art understands, mathematical distributions display summarization (and other aspects) of values of one or more variables in both protected batch of data and the simulated batch of data. Distribution comparison module 273 serves, in various embodiments of the invention, to not only calculate these distributions, but to compare distributions of protected batch of data and the simulated batch of data such as via a chi-square test (or another equivalent mathematical means of determining similarity/difference between distributions). Distribution comparison module 273 then generates a similarity value displaying in mathematical terms a similarity between the distributions for protected batch of data and the simulated batch of data. In embodiments of the invention, similarity value is generated by one or more of distribution comparison module 273, correlation matrix comparison module 275, hierarchy comparison module 277, and relationship comparison module 279 working in conjunction. If the similarity value exceeds a similarity threshold, automated machine learning environment 210 will perform a function utilizing or based upon the simulated batch of data (as further discussed in connection with automated machine learning environment 210).

In further embodiments of the invention, distribution comparison module 273 generates multiple distributions for variable(s) contained in the protected batch of data and the simulated batch of data. Each of the multiple distributions is associated with one or more different technique(s) such as beta, empirical, exponential, gamma, lognormal, normal, triangular, uniform, Weibull, etc. Each distribution generated by distribution comparison module 273 for protected batch of data and simulated batch of data is then tested with a “fit statistic.” a parameter indicating how good a fit for each type of data each distribution is. The distributions with the highest fit statistics are then compared with each other in order to determine the similarity value (as discussed previously).

Correlation matrix comparison module 275 represents software and/or hardware for generation of correlation matrices correlating any two or more variables associated with the protected batch of data or the simulated batch of data (or to determine similarity equivalently). In an embodiment of the invention, correlation matrices display one or more correlations between values of variables included in these batches of data. Correlations between values displayed by correlation matrices are then compared to each other for a quantifiable comparison of data sets, as further discussed herein. As an example, if a result of correlating two or more variables in the generated correlation matrix(ces) for protected batch of data equals 1, the relationship displayed between variables is strong, 0 indicates no valid relationship, and −1 indicates a weak or negative relationship. The results 1, 0, and −1 for the variables in the protected batch of data and simulated batch of data are then compared against each other to determine similarity between the protected batch of data and the simulated batch of data. In embodiments of the invention, each correlation matrix displays correlation between all variables in both protected batch of data and simulated batch of data, and similar comparisons are performed. Therefore, in an embodiment of the invention, comparisons between variables in the simulated batch of data and the protected batch of data include calculation and comparison of correlation matrices of two or more variables associated with the protected batch of data and the simulated batch of data. This presents the advantage of accurate results without excessive processing times, such as if more variables were considered. In further embodiments of the invention, after a comparison between a first set of correlation matrices is performed, another comparison is performed for another set of correlation matrices associated with other variables. After comparison is complete, correlation matrix comparison module 275 then generates a similarity value displaying in mathematical terms a similarity between the one or more correlation matrices. In embodiments of the invention, similarity value is generated by one or more of distribution comparison module 273, correlation matrix comparison module 275, hierarchy comparison module 277, and relationship comparison module 279 working in conjunction. If the similarity value exceeds a similarity threshold, automated machine learning environment 210 will perform a function utilizing or based upon the simulated batch of data (as further discussed in connection with automated machine learning environment 210).

In embodiments of the invention, variables within batches of data considered by correlation matrix comparison module 275 are continuous, categorical, or some combination of these. If variables are continuous, a Pearson correlation value may be utilized to indicate similarity/difference. If the variables are categorical, statistics regarding the variables may be utilized to indicate similarity/difference. If some variables are continuous and others categorical, a comparison for each categorical value of variable A may be compared against traits of continuous variable B can be made (such as min, max, mean, standard deviation, etc.).

Hierarchy comparison module 277 represents software and/or hardware for generation of one or more hierarchy clusters for each of both protected batch of data and simulated batch of data. Each hierarch cluster may be generated by algorithm such as HBDSCAN or the equivalent. In an embodiment of the invention, each generated hierarchy cluster compares all variables in both the protected batch of data and the simulated batch of data, and calculates a relation between these variables. Although calculation of hierarchy clusters for all variables may consume a fair amount of time and computer resources, results of comparison of the batches of data are high quality. In embodiments of the invention, a structure of the cluster is based upon relations of data contained within protected batch of data or simulated batch of data. The relations between the variables displayed by hierarchy clusters are then compared with each other for the relations contained in the variables in the protected batch of data versus the relations contained in variables in the simulated batch of data. Hierarchy clusters generated by hierarchy comparison module 277 may be, in various embodiments of the invention, agglomerative or divisive. Distance between various points in hierarchy clusters may be utilized by hierarchy comparison module 277 in a determination of similarity between protected batch of data and the simulated batch of data. In embodiments of the invention, after comparison(s) are performed, hierarchy comparison module 277 then generates a similarity value displaying in mathematical terms a similarity between the one or more hierarchy clusters. In embodiments of the invention, similarity value is generated by one or more of distribution comparison module 273, correlation matrix comparison module 275, hierarchy comparison module 277, and relationship comparison module 279 working in conjunction. If the similarity value exceeds a similarity threshold, automated machine learning environment 210 will perform a function utilizing or based upon the simulated batch of data (as further discussed in connection with automated machine learning environment 210).

Relationship comparison module 279 represents software and/or hardware for generation of a relationship correlation between one or more traits displayed by one variable, two variables, and/or all variables included in protected batch of data and the simulated batch of data. This presents the advantage of an alternative way to determine similarity between protected batch of data and simulated batch of data which can be used alternatively or in conjunction with other similarity determinations. Various comparisons made by relationship comparison module 279 are then utilized in order to determine in mathematical terms a similarity between protected batch of data and the simulated batch of data. Relationship comparison module 279 then generates a similarity value displaying the similarity between the variables considered. In embodiments of the invention, similarity value is generated by one or more of distribution comparison module 273, correlation matrix comparison module 275, hierarchy comparison module 277, and relationship comparison module 279 working in conjunction. If the similarity value exceeds a similarity threshold, automated machine learning environment 210 will perform a function utilizing or based upon the simulated batch of data (as further discussed in connection with automated machine learning environment 210). As one of skill in the art understands, a comparison of all variables may be more accurate but be more costly in terms of computer processing power necessary to achieve a comparison of all variables.

Display module 281 represents software and/or hardware for displaying outputs/results of various comparisons, similarity values, etc. generated by data comparator 270, as well as display a detected difference between protected batch of data and the simulated batch of data. After performing comparisons between protected batch of data and simulated batch of data discussed herein, display module 281 may display, for example, similarity of traits, distributions, clusters, etc. to provide feedback for a user to understand similarities or differences in the batches of data. This presents the advantage of allowing a data scientist or other user to more easily visualize differences between simulated data and protected data, and make necessary changes to simulated data (or make other changes). Display module 281 may display results in an graphical user interface, browser window, or, in alternative embodiments, in a section of automated machine learning environment 210.

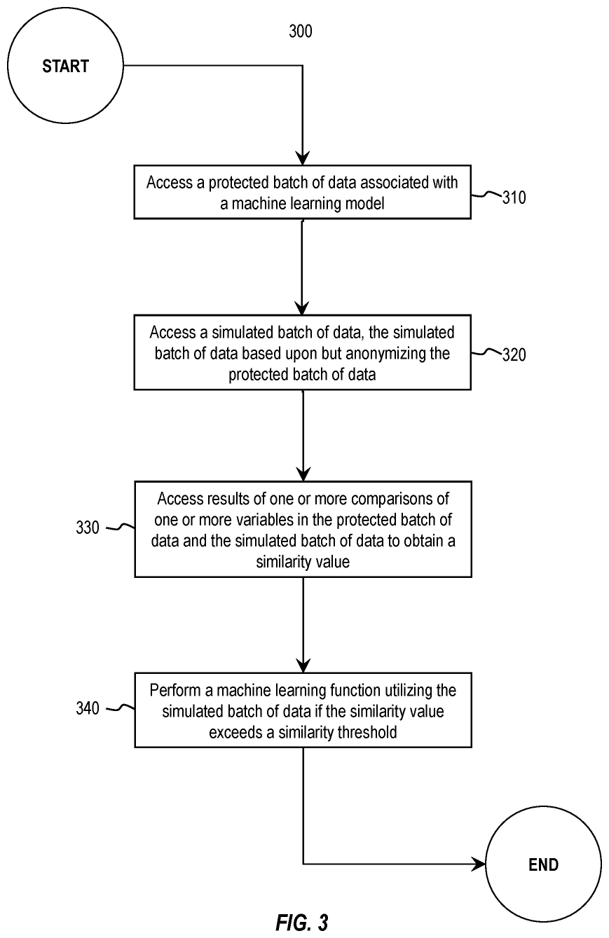

FIG. 3 is a flowchart 300 depicting operational steps that a hardware component, multiple hardware components, and/or a hardware appliance may execute, in accordance with an embodiment of the invention. As shown in FIG. 3, at step 310 automated machine learning environment 210 accesses from data store 240 a protected batch of data associated with a machine learning model. At step 320, automated machine learning environment 210 accesses from data store 240 a simulated batch of data, the simulated batch of data based upon but anonymizing the protected batch of data. At step 330, automated machine learning environment 210 accesses from data comparator 270 results of one or more comparisons of one or more variables in the protected batch of data and the simulated batch of data to obtain a similarity value. At step 340, automated machine learning environment 210 performs a machine learning function if the similarity value exceeds a similarity threshold. An embodiment of the invention such as displayed in FIG. 3 presents the advantage of only allowing training/execution of a machine learning model with synthetic data to proceed if the similarity value exceeds a similarity threshold, thus avoiding bad results while obtaining the advantages presented with utilization of simulated data rather than protected data.

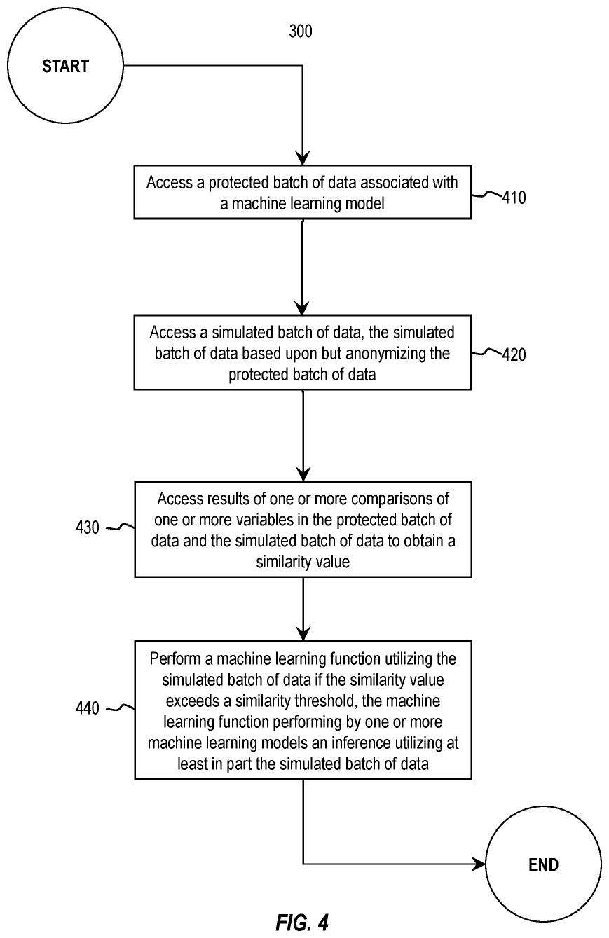

FIG. 4 is a flowchart 400 depicting operational steps that a hardware component, multiple hardware components, and/or a hardware appliance may execute, in accordance with an embodiment of the invention. As shown in FIG. 4, at step 410 automated machine learning environment 210 accesses from data store 240 a protected batch of data associated with a machine learning model. At step 420, automated machine learning environment 210 accesses from data store 240 a simulated batch of data, the simulated batch of data based upon but anonymizing the protected batch of data. At step 430, automated machine learning environment 210 accesses from data comparator 270 one or more comparisons of one or more variables in the protected batch of data and the simulated batch of data to obtain a similarity value. At step 440, automated machine learning environment 210 performs a machine learning function if the similarity value exceeds a similarity threshold, the machine learning function performing by one or more machine learning models an inference utilizing at least in part the simulated batch of data. An embodiment of the invention such as displayed in FIG. 4 presents the advantage of only allowing generation of inferences by a machine learning model using synthetic data if the similarity value exceeds a similarity threshold, thus avoiding bad results while obtaining the advantages presented with utilization of simulated data rather than protected data.

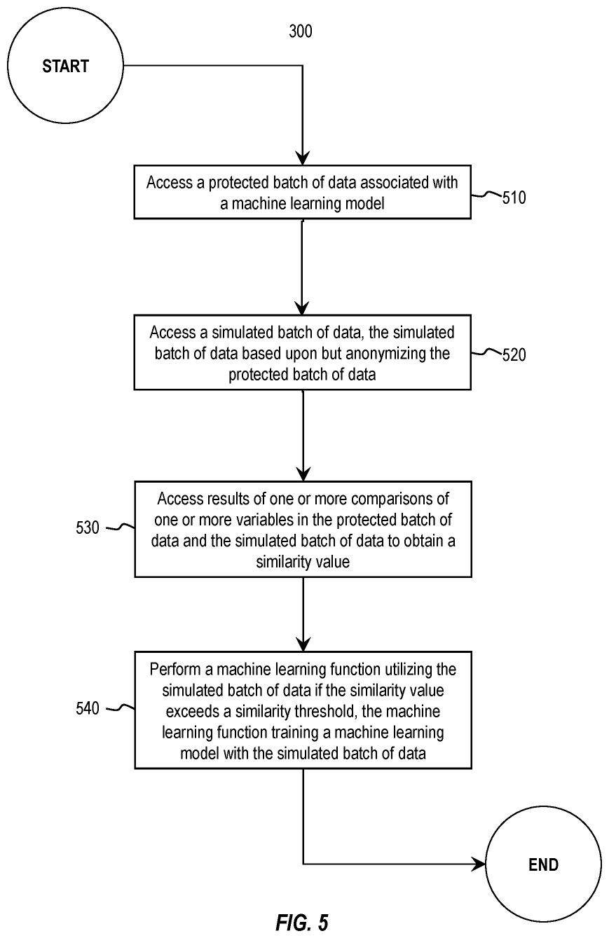

FIG. 5 is a flowchart 500 depicting operational steps that a hardware component, multiple hardware components, and/or a hardware applicant may execute, in accordance with an embodiment of the invention.

As shown in FIG. 5, at step 510 automated machine learning environment 210 accesses from data store 240 a protected batch of data associated with a machine learning model. At step 520, automated machine learning environment 210 accesses from data store 240 a simulated batch of data, the simulated batch of data based upon but anonymizing the protected batch of data. At step 530, automated machine learning environment 210 accesses from data comparator 270 one or more comparisons of one or more variables in the protected batch of data and the simulated batch of data to obtain a similarity value. At step 540, automated machine learning environment 210 performs a machine learning function if the similarity value exceeds a similarity threshold, the machine learning function training a machine learning model with the simulated batch of data. An embodiment of the invention such as displayed in FIG. 5 presents the advantage of only allowing training of machine learning models using synthetic data if the similarity value exceeds a similarity threshold, thus avoiding bad results while obtaining the advantages presented with utilization of simulated data rather than protected data in training machine learning models.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using a computing device to determine whether synthetic data is sufficient for utilization in connection with one or more machine learning models, the method comprising:
accessing by a computing device a protected batch of data associated with a machine learning model;
accessing by the computing device a simulated batch of data, the simulated batch of data based upon but anonymizing the protected batch of data;
access results of one or more comparisons of one or more variables in the protected batch of data and the simulated batch of data to obtain a similarity value; and
performing by the computing device a machine learning function utilizing at least in-part the simulated batch of data if the similarity value exceeds a similarity threshold.

2. The method of claim 1, wherein the machine learning function is performing by one or more machine learning model an inference utilizing at least in-part the simulated batch of data.

3. The method of claim 1, wherein the machine learning function is training a machine learning model with the simulated batch of data.

4. The method of claim 1, wherein the one or more comparisons include comparison of a distribution of one or more variables associated with the protected batch of data and a distribution of one or more variables associated with the simulated batch of data.

5. The method of claim 1, wherein the one or more comparisons include calculation and comparison of correlation matrices of two or more variables associated with the protected batch of data and the simulated batch of data.

6. The method of claim 1, wherein the one or more comparisons include generation of a hierarchy cluster to compare all variables in the protected batch of data and the simulated batch of data.

7. The method of claim 1, wherein the one or more comparisons include generation of a relationship correlation between one or more traits displayed by variables included in the protected batch of data and the simulated batch of data.

8. The method of claim 1, wherein the computing device displays an output of the one or more comparisons, the output displaying a difference in the protected batch of data and the simulated batch of data.

9. A method using a computing device to determine whether synthetic data is sufficient for utilization in connection with one or more machine learning models, the method comprising:
accessing by a computing device a protected batch of data associated with a machine learning model;
accessing by the computing device a simulated batch of data, the simulated batch of data based upon but anonymizing the protected batch of data;
access results of one or more comparisons of one or more variables in the protected batch of data and the simulated batch of data to obtain a similarity value; and
performing by the computing device a machine learning function utilizing at least in-part the simulated batch of data if the similarity value exceeds a similarity threshold, the machine learning function performing by one or more machine learning models an inference utilizing at least in part the simulated batch of data.

10. The method of claim 9, wherein the one or more comparisons include comparison of a distribution of one or more variables associated with the protected batch of data and a distribution of one or more variables associated with the simulated batch of data.

11. The method of claim 9, wherein the one or more comparisons include calculation and comparison of correlation matrices of two or more variables associated with the protected batch of data and the simulated batch of data.

12. The method of claim 9, wherein the one or more comparisons include generation of a hierarchy cluster to compare all variables in the protected batch of data and the simulated batch of data.

13. The method of claim 9, wherein the one or more comparisons include generation of a relationship correlation between one or more traits displayed by variables included in the protected batch of data and the simulated batch of data.

14. A method using a computing device to determine whether synthetic data is sufficient for utilization in connection with one or more machine learning models, the method comprising:
accessing by a computing device a protected batch of data associated with a machine learning model;
accessing by the computing device a simulated batch of data, the simulated batch of data based upon but anonymizing the protected batch of data;
access results of one or more comparisons of one or more variables in the protected batch of data and the simulated batch of data to obtain a similarity value; and
performing by the computing device a machine learning function utilizing at least in-part the simulated batch of data if the similarity value exceeds a similarity threshold, the machine learning function training a machine learning model with the simulated batch of data.

15. The method of claim 14, wherein the one or more comparisons include comparison of a distribution of one or more variables associated with the protected batch of data and a distribution of one or more variables associated with the simulated batch of data.

16. The method of claim 14, wherein the one or more comparisons include calculation and comparison of correlation matrices of two or more variables associated with the protected batch of data and the simulated batch of data.

17. The method of claim 14, wherein the one or more comparisons include generation of a hierarchy cluster to compare all variables in the protected batch of data and the simulated batch of data.

18. The method of claim 14, wherein the one or more comparisons include generation of a relationship correlation between one or more traits displayed by variables included in the protected batch of data and the simulated batch of data.

19. A computer system to determine whether synthetic data is sufficient for utilization in connection with one or more machine learning models, the computer system comprising:
one or more computer processors;
one or more computer-readable storage media;
program instructions stored on the computer-readable storage media for execution by at least one of the one or more processors, the program instructions comprising:
program instructions to access a protected batch of data associated with a machine learning model;
program instructions to access a simulated batch of data, the simulated batch of data based upon but anonymizing the protected batch of data;
program instructions to access results of one or more comparisons of one or more variables in the protected batch of data and the simulated batch of data to obtain a similarity value; and
program instructions to perform a machine learning function utilizing at least in-part the simulated batch of data if the similarity value exceeds a similarity threshold.

20. The computer system of claim 19, wherein the one or more comparisons include comparison of a distribution of one or more variables associated with the protected batch of data and a distribution of one or more variables associated with the simulated batch of data.

21. The computer system of claim 19, wherein the one or more comparisons include calculation and comparison of correlation matrices of two or more variables associated with the protected batch of data and the simulated batch of data.

22. The computer system of claim 19, wherein the one or more comparisons include generation of a hierarchy cluster to compare all variables in the protected batch of data and the simulated batch of data.

23. The computer system of claim 19, wherein the one or more comparisons include generation of a relationship correlation between one or more traits displayed by variables included in the protected batch of data and the simulated batch of data.

24. A computer program product to determine whether synthetic data is sufficient for utilization in connection with one or more machine learning models, the computer program product comprising:
one or more non-transitory computer-readable storage media and program instructions stored on the one or more non-transitory computer-readable storage media capable of performing a method, the method comprising:
accessing by a computing device a protected batch of data associated with a machine learning model;
accessing by the computing device a simulated batch of data, the simulated batch of data based upon but anonymizing the protected batch of data;
access results of one or more comparisons of one or more variables in the protected batch of data and the simulated batch of data to obtain a similarity value; and
performing by the computing device a machine learning function utilizing at least in-part the simulated batch of data if the similarity value exceeds a similarity threshold.

25. The computer program product of claim 24, wherein the computing device displays an output of the one or more comparisons, the output displaying a difference in the protected batch of data and the simulated batch of data.
